(19) United States
(12) Patent Application Publication
(10) Pub. No.: US 2025/0340178 A1
(43) Pub. Date: Nov. 6, 2025

(54) FUEL CELL SYSTEM CONTAINMENT ARCHITECTURE FOR A REFUSE VEHICLE

(71) Applicant: Oshkosh Corporation, Oshkosh, WI (US)

(72) Inventor: Vince Schad, Oshkosh, WI (US)

(73) Assignee: Oshkosh Corporation, Oshkosh, WI (US)

(21) Appl. No.: 19/197,795

(22) Filed: May 2, 2025

Related U.S. Application Data
(60) Provisional application No. 63/642,051, filed on May 3, 2024.

(51) Int. Cl. B60R 16/033; B60K 15/00; B60K 15/03; B60K 15/063; B60L 1/00; B65F 3/04; H01M 8/04082; H01M 16/00

(52) U.S. Cl. CPC B60R 16/033; B60K 15/00; B65F 3/04; H01M 8/04201; H01M 16/006; B60K 2015/03315; B60K 2015/0638; B60L 1/003; H01M 2220/20; H01M 2250/20; H01M 2250/402

(57) ABSTRACT

A refuse vehicle includes a chassis, a body coupled to the chassis and including a refuse container for receiving and storing refuse therein, and a fuel cell system coupled to at least one of the chassis or the body. The fuel cell system includes a plurality of primary components: a fuel storage volume, a fuel cell, an energy storage device, and a motor. The fuel cell system further includes a subsystem module including a housing for coupling at least two of the primary components to the chassis or the body.

### CROSS-REFERENCE TO RELATED PATENT APPLICATIONS

This application claims the benefit of and priority to U.S. Provisional Patent Application 63/642,051, filed May 3, 2024, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a refuse vehicle. The refuse vehicle includes a chassis, a body, and a fuel cell system. The body is coupled to the chassis and includes a refuse container configured to receive and store refuse therein. The fuel cell system is coupled to at least one of the chassis or the body. The fuel cell system includes a plurality of primary components and a subsystem module. The plurality of primary components includes a fuel storage volume, a fuel cell, an energy storage device, and a motor. The subsystem module includes a housing configured to couple at least two of the primary components to the chassis or the body.

In some embodiments, the body further includes a tailgate that is movably coupled to the refuse container, where at least one of the primary components is disposed on the tailgate. In some embodiments, the subsystem module is disposed on a roof of the body. In some embodiments, the body further includes a tailgate that is movably coupled to the refuse container, where the subsystem module is disposed on the tailgate. In some embodiments, the housing is configured to contain the fuel storage volume and the fuel cell. In some embodiments, the body further includes a tailgate that is movably coupled to the refuse container, where the fuel storage volume is disposed on the tailgate, and the subsystem module is supported by the refuse container. In some embodiments, the subsystem module is disposed on a forward end of the body.

In some embodiments, the subsystem module further includes a fuel conduit and an electrical cable, and where the housing further includes a partition separating at least a portion of the fuel conduit from the electrical cable. In some embodiments, the subsystem module includes an electric power take-off system including the motor and a hydraulic pump.

Another embodiment relates to a fuel cell system for a refuse vehicle including a plurality of primary components including a fuel storage volume, a fuel cell, an energy storage device, and a motor. The fuel cell system further includes a subsystem module including a housing coupled to a roof of the refuse vehicle, where at least two of the primary components are positioned within the housing, and at least one of the primary components is positioned external to the subsystem module and connected to the subsystem module.

In some embodiments, the fuel cell and the energy storage device are positioned within the housing of the subsystem module. In some embodiments, the fuel storage vessel is positioned external to the subsystem module, where the fuel storage vessel is connected to the fuel cell of the subsystem module. In some embodiments, at least three of the primary components are positioned within the housing of the subsystem module.

In some embodiments, the fuel cell system further includes a second subsystem module including a housing, where at least two of the primary components are positioned within the housing of the second subsystem module. The second subsystem module is connected to the subsystem module. In some embodiments, the fuel storage vessel and the fuel cell are positioned within the housing of the subsystem module. In some embodiments, the energy storage device and the motor are positioned within the housing of the second subsystem module.

Another embodiment relates to a refuse vehicle including a chassis, a body coupled to the chassis and including a refuse container configured to receive and store refuse therein, and a fuel cell system coupled to at least one of the chassis or the body. The fuel cell system includes a plurality of primary components including a fuel storage volume, a fuel cell, an energy storage device, and a motor. The fuel cell system further includes a first subsystem module including a first housing coupled to a roof of the body of the refuse vehicle, where at least two of the primary components are positioned within the first housing, and a second subsystem module including a second housing coupled to at least one of the chassis or the body of the refuse vehicle, where the second subsystem module is connected to the first subsystem module and at least two of the primary components are positioned within the second housing.

In some embodiments, the fuel storage vessel and the fuel cell are positioned within the first housing. In some embodiments, the energy storage device and the motor are positioned within the second housing. In some embodiments, the body further includes a tailgate that is movably coupled to the refuse container, where the second subsystem module is disposed on the tailgate.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a front-loading refuse vehicle inclusive of a fuel cell containment architecture, according to an exemplary embodiment;

FIG. 2 is a block diagram of the fuel cell containment architecture of FIG. 1;

FIG. 3 is a block diagram of an electric power take-off system that may be with the fuel cell containment architecture of FIG. 1, according to an exemplary embodiment;

FIG. 4 is a side view of a front-loading refuse vehicle inclusive of fuel cell containment architecture, according to another exemplary embodiment;

FIG. 5 is a block diagram of the fuel cell containment architecture of FIG. 4; and

FIG. 6 is perspective view of a refuse vehicle inclusive of a fuel cell containment architecture, according to yet another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, systems and methods of integrating a fuel cell system onto a refuse vehicle are shown, according to various exemplary embodiments. The fuel cell system includes multiple subsystems and/or primary components that interact with one another to generate electricity onboard the refuse vehicle. Electricity from the fuel cell system may be used to power a hydraulic system (e.g., a hydraulic pump, etc.) and/or other auxiliary systems of the refuse vehicle (referred to herein generally as “vehicle subsystems”). For example, the primary components of the fuel cell system may include a fuel storage vessel, a fuel cell, and an energy storage device (e.g., a battery pack, etc.). In some embodiments, the primary components of the fuel cell system also include a motor to convert electrical energy from the battery pack into hydraulic power or to otherwise power various actuators of the vehicle subsystems. In other embodiments, the energy storage device may be used to power electrical actuators used in one or more vehicle subsystems.

In at least one embodiment, the fuel cell system includes a subsystem module (e.g., a subsystem pod, etc.) housing at least two subsystems and/or primary components of the fuel cell system in a single location along the refuse vehicle. For example, the subsystem module may include a housing (e.g., an enclosure, etc.) containing both the fuel cell and the energy storage device. In some embodiments, the motor of the fuel cell system is also positioned within the housing. In other embodiments, the subsystem module may include a housing containing both the fuel storage tank and the fuel cell separate from the energy storage device. In yet other embodiments, the subsystem module includes all of the primary components of the fuel cell system.

Beneficially, pairing at least two subsystems and/or primary components of the fuel cell system into a single module can reduce the overall length of conduits (e.g., high voltage cables, fuel lines, etc.) that are used to connect the primary components to one another and to the refuse vehicle. Such an arrangement can also simplify servicing of the refuse vehicle by placing the primary components in a single location and apart from other vehicle components/subsystems.

In some embodiments, the subsystem module is detachably coupled to the refuse vehicle, which can enable replacement of the entire module in case of damage to any of the primary components without requiring complex vehicle teardown operations or removal of other system components to access parts of the fuel cell system. Such an arrangement also enables positioning of at least one primary component of the fuel cell system on the tailgate of the refuse vehicle, which can improve the weight distribution and improve lift capacity for front-loading refuse vehicle configurations.

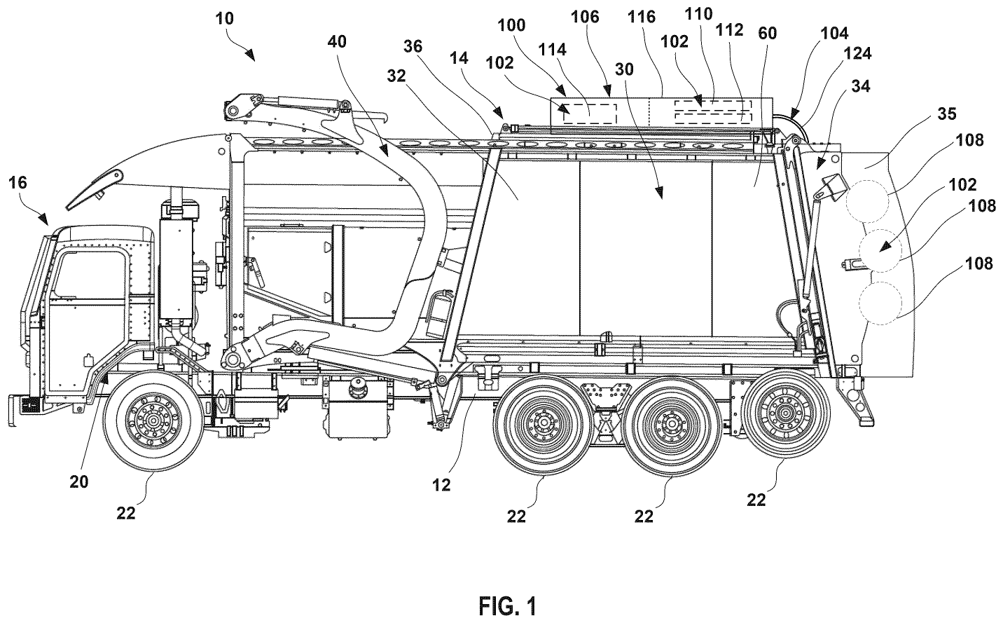

Referring to FIG. 1, a vocational vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the vehicle (e.g., computers, controllers, processors, etc.). The refuse vehicle 10 further includes a prime mover 20 coupled to the frame 12 at a position beneath the cab 16. The prime mover 20 provides power to a plurality of motive members, shown as wheels 22, and to other systems of the vehicle (e.g., a pneumatic system, a hydraulic system, an electric system, etc.). A pair of wheels 22 may be coupled to an axle that is coupled to, and supported by, the frame 12. The refuse vehicle 10 may include at least two axles. In some embodiments, the refuse vehicle 10 may include at least four axles, and may include five axles in various embodiments herein.

In some embodiments, the prime mover 20 is an internal combustion engine that is configured to generate power using one or more fuels. For example, the internal combustion engine may be configured to use a variety of fuels (e.g., gasoline, diesel, biodiesel, ethanol, natural gas, etc.), according to various exemplary embodiments. According to an alternative embodiment, the prime mover 20 includes one or more electric motors coupled to the frame 12. The electric motors may consume electrical power from an on-board storage device (e.g., batteries, ultra-capacitors, etc.), from an on-board generator (e.g., a fuel cell, an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and on-board refuse container, in particular, defines a refuse compartment 30 (e.g., a collection chamber, etc.). In some embodiments, the body 14 includes a plurality of panels, shown as panels 32, a tailgate 34, and a cover 36 that together define the refuse compartment 30. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top wall (e.g., an upper wall, the cover 36, a top surface, etc.) of the on-board refuse container. In other embodiments, a different connection mechanism may be used to support the tailgate 34 on the body 14. In some embodiments, the body 14 further includes a tailgate actuation system including a tailgate actuator to selectively open the tailgate 34 and to facilitate removal of refuse materials stored in the refuse compartment 30.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door is movably coupled along the cover 36 to seal the opening thereby preventing refuse from escaping the refuse compartment 30 (e.g., due to wind, bumps in the road, etc.).

In some embodiments, the refuse vehicle 10 also includes other application-specific hydraulic systems including hydraulic actuators (e.g., hydraulic cylinders, etc.) and/or electric actuator systems including electrical actuators (e.g., ball screw actuators, etc.) to control vehicle operations. For example, the refuse vehicle 10 may include an ejector system including an ejector (e.g., a packer, a compactor, etc.) and an ejector actuator that is configured to move the ejector to compact loose refuse material within the refuse compartment 30, and/or to eject the refuse material through the tailgate 34. In some embodiments, the refuse vehicle 10 also includes a cover actuator to control movement of the door of the refuse vehicle 10. In some embodiments, the refuse vehicle 10 also includes a service lift actuator to move (e.g., tilt, etc.) the body 14 relative to the frame 12. In some embodiments, at least one of the actuators is a hydraulic actuator including a hydraulic cylinder driven by hydraulic pressure from one or more hydraulic pumps onboard the vehicle, as will be further described. In other embodiments, at least one of the actuators is an electrical actuator driven by an electric motor. In other embodiments, the refuse vehicle 10 includes additional, fewer, and/or different auxiliary systems including one or more actuators.

Although embodiments disclosed herein are described with reference to a refuse vehicle, and particularly to a front-loading refuse vehicle, it should be understood that the fuel cell system containment architectures and methods of the present disclosure may also be used on other vehicle types including, but not limited to, side-loading refuse vehicles, rear-loading refuse vehicles, cement trucks (e.g., mixer vehicles), dump trucks, and other on and off-highway vehicles having hydraulically and/or electrically actuated systems.

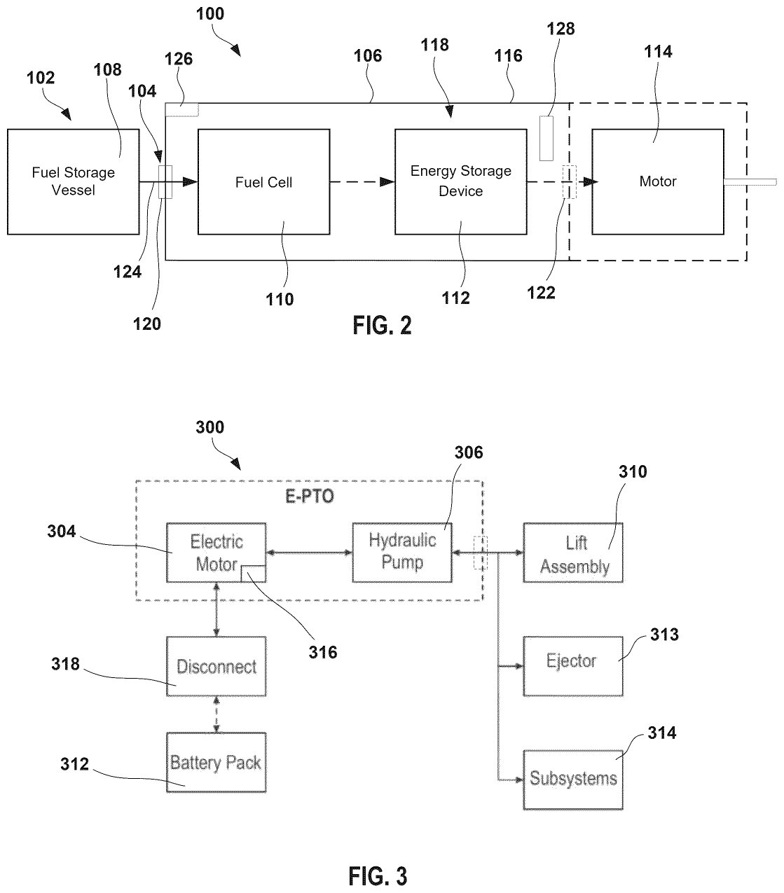

Referring to FIGS. 1-2, the refuse vehicle 10 includes a fuel cell system 100 coupled to body 14. Among other benefits, such an arrangement can enable retrofit of the fuel cell system 100 onto various vehicle chassis arrangements, such as to chassis configurations produced by various third-party manufacturers. Such an arrangement can also enable use of the fuel cell system 100 as a standalone power system for different electric vehicle chassis, and/or to supplement power provided by another prime mover of an electric vehicle chassis. In other embodiments, at least a portion of the fuel cell system 100 may be coupled to the frame 12 (e.g., between the frame rails of the frame 12, above the frame 12 between the cab 16 and the body 14, etc.).

The fuel cell system 100 is configured to generate electrical energy from a gaseous or liquid fuel, and to use the electrical energy to power one or more vehicle subsystems onboard the refuse vehicle 10. The fuel cell system 100 includes a plurality of fuel cell subsystems including a plurality of primary components 102 and a plurality of secondary components 104. The fuel cell system 100 also includes a subsystem module 106 that is configured to couple at least two of the primary components 102 to the refuse vehicle 10.

The primary components 102 include components that are configured to power other components or to generate, store, and/or convert energy between different forms. The secondary components include auxiliary hardware, such as flow tubes, electrical connections, and other hardware used to connect the various primary components 102 together or to other vehicle subsystems. In the embodiment of FIG. 1, the primary components 102 include a fuel storage volume 108, a fuel cell 110, an energy storage device 112, and a motor 114. In other embodiments, the fuel cell subsystems include additional, fewer, and/or different primary components.

The fuel storage volume 108 is configured to contain a liquid or gaseous fuel onboard the refuse vehicle 10. In the embodiment of FIG. 1, the fuel storage volume 108 is one of a plurality of fuel storage volumes 108 that are mounted to the body 14. Each of the fuel storage volumes may include a fuel tank (e.g., a fuel reservoir, a pressurized fuel cylinder, etc.) that is configured to store hydrogen gas at elevated pressure (e.g., up to a pressure range between and including 5,000 psi and 10,000 psi when each fuel tank is full, etc.). In the embodiment of FIG. 1, the fuel storage volumes are disposed on the tailgate 34 of the refuse vehicle 10, within a tailgate enclosure 35 that is defined by the tailgate 34. In some embodiments, the fuel storage volumes are arranged along a lateral direction (e.g., into the page as shown in FIG. 1, so that a central axis of the fluid storage volumes extends parallel to the lateral direction, etc.) and are stacked in a vertical direction, which can simplify removal and replacement of individual ones of the fluid storage volumes. In other embodiments, the arrangement of the fuel storage volumes may be different. For example, the fluid storage volumes may be arranged along the vertical direction or in another arrangement.

The fuel cell 110 (e.g., a fuel cell assembly, etc.) includes an electrochemical device that is configured to generate electricity from the chemical energy of hydrogen. In some embodiments, the fuel cell 110 is part of a fuel cell stack having a plurality of individual fuel cells 110 that are arranged in a series or parallel configuration to increase a rate of generation of electrical power. Each fuel cell 110 includes an anode, a cathode, and an electrolyte membrane. Hydrogen gas is supplied to the anode side of the fuel cell 110 and oxygen (e.g., air, etc.) is supplied to the cathode, causing a chemical reaction that generates electrical energy which may be used to power other vehicle systems or stored for later use.

The energy storage device 112 is configured to store electrical energy produced by the fuel cell 110. In some embodiments, the energy storage device 308 includes a battery pack including a battery. The battery pack is electrically coupled to the motor 114 and powers operation of the motor 114. In other embodiments, the energy storage device 112 includes a capacitor. The energy storage device 112 can be used to provide power to different vehicle subsystems and/or the motive members (e.g., the wheels 22, etc.) to drive movement of the refuse vehicle 10.

The subsystem module 106 is configured to contain at least two of the fuel cell subsystems (e.g., at least two of the primary components 102) onboard the refuse vehicle 10 adjacent to one another. The subsystem module 106 includes a housing 116 (e.g., an enclosure, a pod, etc.) that is configured to couple at least two of the primary components 102 to the frame 12 and/or the body 14. In the embodiment of FIGS. 1-2, both the fuel cell 110 and the energy storage device 112 are disposed within the housing 116. In such an arrangement, the housing 116 separates (e.g., isolates, etc.) the electrical components (e.g., high voltage cables and connections, etc.) of the fuel cell system 100 from the fuel storage volume(s) 108, which can reduce the risk of fire or explosion that could be caused by electrical sparks in the presence of leaking hydrogen gas. Such an arrangement also eliminates the need to route high voltage electrical cables across the pivot for the tailgate 34.

In the embodiment of FIG. 1, the housing 116 is disposed on a roof (e.g., on the cover 36) of the refuse vehicle 10 and extends along a portion of the roof that is proximate to the tailgate 34. As described above with respect to the fluid storage volume(s), positioning the subsystem module 106 near a rear end of the refuse vehicle can improve weight distribution and lift capacity of the lift assembly 40. Such an arrangement also positions the subsystem module 106 adjacent to the tailgate 34, which reduces the length of conduit (e.g., flow tubing for the hydrogen gas, gas lines/conduit, etc.) between the subsystem module 106 and the fluid storage volumes, and the overall length of conduit across the refuse vehicle 10.

Referring again to FIGS. 1-2, the housing 116 includes exterior walls defining an enclosed interior cavity 118 (e.g., a waterproof cavity, etc.) that is protected from environmental conditions outside of the housing 116. The housing 116 is configured to be mounted to the body 14 of the refuse vehicle 10. In some embodiments, the housing 116 includes a mounting flange, or openings to facilitate mounting of the housing 116 to the body 14. In at least one embodiment, the housing 116 is detachably coupled to the body 14 and is removable from the body 14 without damaging the body 14. In some embodiments, the housing 116 includes at least one vent opening to facilitate cooling of interior components. In other embodiments, the subsystem module 106 includes an insulating material to reduce heat transfer away from the fuel cell 110, which can improve the overall operating efficiency of the fuel cell 110.

In some embodiments, the subsystem module 106 and/or other enclosures for the fuel cell system also include one or more sensors, shown as sensor 126, that are configured to monitor conditions therein and to transmit data indicative of one or more conditions to a controller (e.g., a controller for the subsystem module 106, a controller for the fuel cell system, a central vehicle controller, etc.). The subsystem module 106 and/or other parts of the fuel cell system may also include remediation system(s) 120 to reduce the risk of gas leakage and/or electrical sparking within the housing 116 and/or other enclosures supporting the primary components 102 and/or the secondary components 104, as will be further described.

In the embodiment of FIG. 2, the subsystem module 106 includes pass-throughs (e.g., interconnects, fittings, etc.), shown as a first pass-through 120 and a second pass-through 122 extending through the exterior walls of the housing 116 that are used to connect the subsystem module 106 to other primary components 102 of the fuel cell system 100.

In the embodiment of FIG. 2, the first pass-through 120 is a fuel pass-through that is configured to fluidly couple at least one fuel line 124 from the fuel storage volume 108 to the fuel cell 110. The first pass-through 120 may include a grommet-style pass-through (e.g., a flexible rubber or plastic grommet providing a sealed barrier around a fuel line, etc.), a bulkhead fitting (e.g., a threaded fitting with a nut on each side of a wall for maintaining a sealed connection between a fuel line and the housing, etc.), or another time of fuel pass-through providing a sealed connection between a fuel transfer line and the housing 116. In at least one embodiment, the first pass-through 120 includes a connector that enables selective fluid connection between the at least one fuel line 124 and the subsystem module 106 (e.g., the fuel cell 110, etc.). Among other benefits, such an arrangement can simplify decoupling of the subsystem module 106 from the refuse vehicle 10 for servicing or replacement.

Referring still to FIG. 2, in some embodiments, the second pass-through 122 is an electrical pass-through that is configured to electrically connect the subsystem module 106 to the motor 114. In such instances, the motor 114 may be located outside of the housing 116 (e.g., adjacent to the housing 116 or in another location along the refuse vehicle 10). In other embodiments, the motor 114 is also disposed within the housing 116 so that all of the components are co-located within the housing, which can significantly reduce the size and weight of connecting hardware between the primary components 102. Such an arrangement can also remove the need for specialized connecting hardware that can withstand the environment outside of the housing 116. In such instances, a hydraulic pump may also be positioned within the housing, which eliminates the need for a separate mechanical pass-through between the motor 114 and the hydraulic pump.

Referring to FIG. 3, in some embodiments, the motor 304 of the fuel cell system and/or a hydraulic pump 306 together define an electric power take-off system (E-PTO) 300 that is coupled to the chassis (e.g., the frame 12 of FIG. 1). The E-PTO system 300 is configured to receive electrical power from an energy storage device 312 and/or other power sources and to convert the electrical power to hydraulic power for different subsystems on the refuse vehicle. The energy storage device 312 may be the same as the energy storage device 112 described with reference to FIGS. 1-2. In such embodiments, the E-PTO system 300 receives electrical power from the energy storage device 312 and provides the electrical power to the motor 304. The motor 304 drives the hydraulic pump 306, which provides pressurized hydraulic fluid to different vehicle subsystems, such as a lift assembly 310 (e.g., the lift assembly 40 of FIG. 1), an ejector system 313, or other subsystems 314 (e.g., the tailgate actuator system, etc.).

In some embodiments, the E-PTO system 300 includes an E-PTO controller 316. The E-PTO controller 316 may be configured to monitor various systems within the refuse vehicle, including the E-PTO system 300. The E-PTO controller 316 may be configured to receive data from sensors (e.g., the sensor 126 of the subsystem module 106 of FIG. 2, etc.) within the system, compare the data to expected values under normal operating conditions, adjust the operation parameters of components of the system, and determine if a critical operating condition exists based on the sensor data. Further, the E-PTO controller 316 may be configured to shut down the system and/or the refuse vehicle in response to detecting a critical operating condition, such as a gas leak detected within an enclosure for the fuel storage vessel(s) and/or the housing of the subsystem module.

In some embodiments, the refuse vehicle further includes a disconnect 318 positioned between the energy storage device 312 and the E-PTO system 300 to allow different vehicle subsystems (e.g., the ejector system 313, the lift assembly 310, and/or other subsystems 314, etc.) to be decoupled and de-energized from the energy storage device 312. For example, the E-PTO controller 316 may be configured to cause the disconnect 318 to be decoupled and de-energized from the energy storage device 312 in the event of system malfunction.

In some embodiments, the E-PTO controller 316 is part of a controller for the fuel cell system that is configured to control operation of one or more remediation systems (such as remediation system 128 in FIG. 2) onboard the refuse vehicle, such as to reduce the risk of explosion due to leaking hydrogen gas, or potential electrical hazards associated with the fuel cell system. For example, the controller may be configured to receive data from one or more sensors (e.g., the sensor 126 of FIG. 2, etc.) and to determine, based on the sensor data, one or more conditions within the subsystem module or another enclosure. For example, the controller may be configured to determine an amount of hydrogen gas or other fuel within a housing of the subsystem module based on the sensor data.

In some embodiments, the controller is configured to control operation of a remediation system (e.g., the remediation system 128 in FIG. 2) based on the sensor data. For example, the controller may be configured to activate a blower (e.g., a fan, etc.) and/or open valves/dampers to vent the fuel from the housing. In some embodiments, the controller is also configured to generate alerts based on conditions within the housing, such as by generating a visual indicator identifying the condition on a user interface, or by sounding an audible alarm within the cab of the vehicle. In some embodiments, the controller is configured to deactivate primary components of the fuel cell system and/or decouple (e.g., via valves, electrical disconnects, etc.) primary components from one another or from the fuel storage vessel(s).

The arrangement of components of the fuel cell system 100 described with respect to FIGS. 1-3 should not be considered limiting. It should be understood that various alternative arrangements are possible without departing from the inventive principles disclosed herein. For example, in some embodiments, the arrangement of the fuel storage volume 108, the fuel cell 110, and the energy storage device 112 described in FIGS. 1-2 may be reversed such that the fuel cell 110 and the energy storage device 112 are disposed on the tailgate 34, and the fuel storage volume 108 is disposed on the roof of the body 14. In other embodiments, the arrangement of components for the fuel cell system may be different.

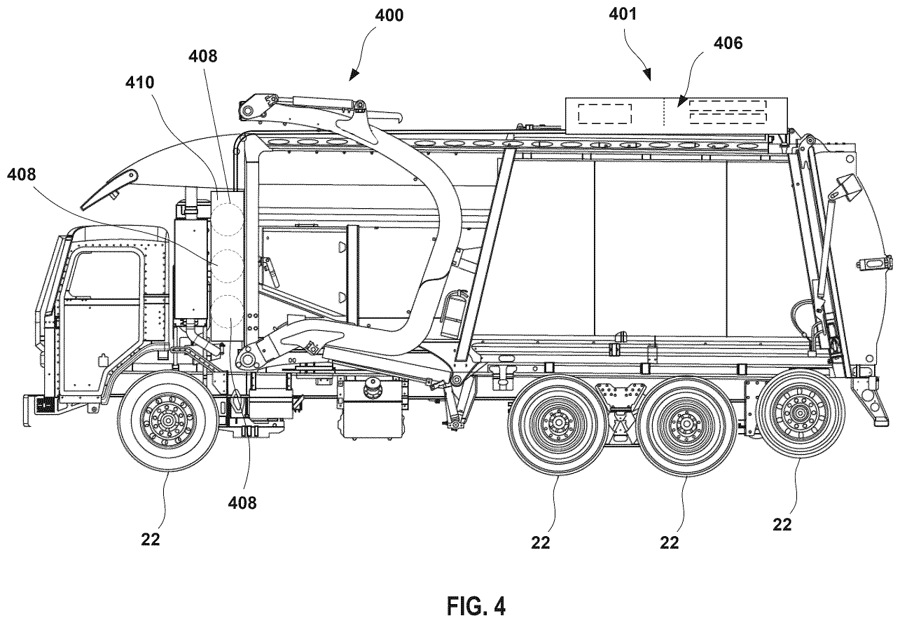

Referring to FIG. 4, a refuse vehicle 400 is shown that includes a fuel cell system 401 having a plurality of fuel storage volumes 408 disposed on a forward end of the body 14 instead of on the tailgate 34. The fuel storage volumes 408 may be disposed within an enclosure 410 (e.g., a fuel tank housing, etc.) to prevent inadvertent access to the fuel storage volumes 408 and to protect the fuel storage volumes 408 from other external hazards. In the embodiment of FIG. 4, the enclosure 410 is mounted to a forward wall of the body 14. In other embodiments, the enclosure 410 may be mounted to the chassis, or to a portion of a body frame that extends forward of the refuse container. The enclosure 410 and the fuel storage volumes 408 are positioned between the cab 16 and the body 14, which can provide further protection to the fuel storage volumes 408, and can reduce drag on the vehicle during transit operations. Positioning the fuel storage volumes 408 at the forward end of the body 14 also eliminates the need to route hydrogen transfer lines across pivot points along the body, which can reduce the risk of damage to the hydrogen transfer lines and increase service life.

The fuel cell system 401 also includes a subsystem module 406, which may be the same as or similar to the arrangement of the subsystem module 106 described with reference to FIGS. 1-2. In other embodiments, the arrangement of the subsystem module 406 and the fuel storage volumes 408 may be reversed.

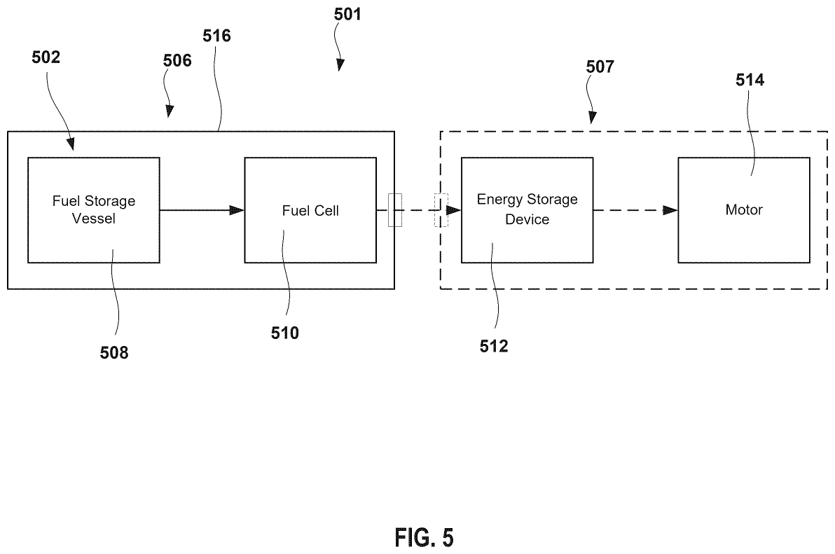

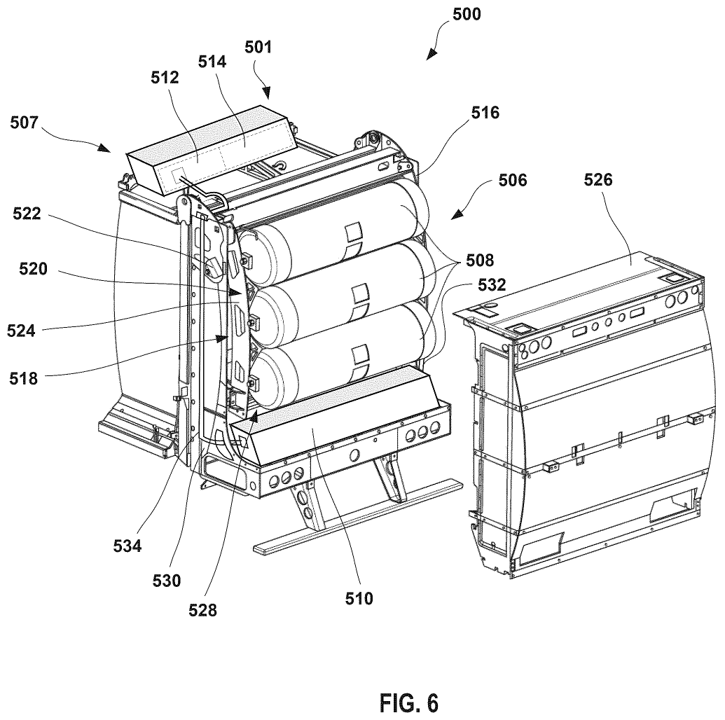

Referring to FIGS. 5-6, a fuel cell system 501 for a refuse vehicle 500 is shown that includes a first subsystem module 506 that is disposed on the tailgate 34 of the refuse vehicle 500 and a second subsystem module 507 disposed on a roof of the refuse vehicle 500.

The first subsystem module 506 includes a housing 516 (e.g., an enclosure, a container, etc.) that is mounted to the tailgate 34 and that supports a plurality of primary components 502 on the tailgate 34. In the embodiment of FIGS. 5-6, the housing 516 is configured to contain both a fuel storage volumes 508 of the fuel cell system 501 and a fuel cell 510.

In the embodiment of FIG. 6, the housing 516 is integrally formed with the tailgate 34 so that at least a portion of the housing 516 is defined by the tailgate 34 itself. The tailgate 34 defines a recessed area 518 including a rack 520 disposed therein for supporting the fuel storage volumes 508 along a lateral direction within the tailgate 34. In some embodiments, the rack 520 is movable relative to the tailgate 34, which can facilitate access to the fuel storage volumes 508 for servicing or replacement. For example, the rack 520 may be rotatable about a pivot 522 disposed at an upper end of the rack 520.

In some embodiment, the rack 520 includes two parallel support elements 524 (e.g., two parallel panels, etc.) that extend along opposing sides of the fuel storage volumes 508 and that are mounted to the fuel storage volumes 508 at the opposing sides. In some embodiments, the rack 520 supports the fuel storage volumes 508 in an arc-shaped arrangement within the housing 516 when viewed from a lateral side of the refuse vehicle 500. In other embodiments, the arrangement of the fuel storage volumes 508 is different.

The housing 516 also includes a second housing portion 526 (e.g., a cover, etc.) that is configured to detachably couple to the tailgate 34 and to facilitate access to the fuel storage volumes 508. Together, the tailgate 34 and the second housing portion 526 define an enclosed interior cavity 528. The housing 516 provides a weatherproof seal between the interior cavity 528 of the housing 516 and the environment surrounding the refuse vehicle 500.

In the embodiment of FIG. 6, the fuel cell 510 is disposed at a lower end of the interior cavity 528 and the fuel storage volumes 508 are disposed above the fuel cell 510. Such an arrangement can facilitate access to the fuel cell 510, which may require more frequent maintenance relative to the fuel storage volumes 508. In other embodiments, the arrangement of the fuel cell 510 and the fuel storage volumes 508 may be different.

The housing 516 includes a partition 530 that separates portions of the fuel cell 510 from the fuel storage volumes 508 and at least partially isolates portions of the fuel cell 510 from the fuel storage volumes 508. In the embodiment of FIG. 6, the partition 530 is a panel that extends vertically along an entire length of the housing 516 and separates at least a portion of a fuel conduit 532 (e.g., a hydrogen transfer line) that extends between the fuel storage volumes 508 and the fuel cell 510, and an electrical cable 534 that is configured to electrically couple the fuel cell 510 to the energy storage device (e.g., the second subsystem module 507). In some embodiments, the partition 530 defines a firewall within the housing 516 that separates the electrical hardware from the fuel transfer lines and equipment.

In some embodiments, the fuel conduit 532 and the electrical cable 534 are connected to the fuel cell 510 on opposite sides of the fuel cell 510, which can further reduce the risk of fire or explosions within the housing 516. In at least one embodiment, the housing 516 also includes a partition between the fuel storage volumes 508 and the fuel cell 510. It should be appreciated that the number and arrangement of partitions may be different in various embodiments.

The second subsystem module 507 includes a motor 514 and an energy storage device 512, both of which are located remote from the first subsystem module 506. In at least one embodiment, the second subsystem module 507 also includes a hydraulic pump that is powered by the motor 514. In such embodiments, the second subsystem module 507 may also include an E-PTO system as described with reference to FIG. 3 above.

Referring still to FIGS. 5-6, each of the first subsystem module 506 and the second subsystem module 507 include pass-throughs to facilitate electrical connections between the first subsystem module 506 and the second subsystem module 507. The pass-throughs may comprise electrical pass-throughs (e.g., bulkhead fittings, etc.), which simplify decoupling the first subsystem module 506 and the second subsystem module 507 from one another and from the refuse vehicle 500, such as for servicing or replacement.

In the arrangement of FIGS. 5-6, multiple primary systems of the fuel cell system 501 are positioned on the tailgate 34, which can significantly improve weight distribution across the vehicle and, in certain implementations, can also increase the lifting capacity of a lift assembly onboard the vehicle. The arrangement also eliminates the need for a separate hydraulic connection or transfer lines over the tailgate pivot.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vocational vehicles as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body coupled to the chassis and comprising a refuse container configured to receive and store refuse therein;
a fuel cell system coupled to at least one of the chassis or the body, the fuel cell system comprising:
a plurality of primary components comprising a fuel storage volume, a fuel cell, an energy storage device, and a motor; and
a subsystem module comprising a housing configured to couple at least two of the primary components to the chassis or the body.

2. The refuse vehicle of claim 1, wherein the body further comprises a tailgate that is movably coupled to the refuse container, wherein at least one of the primary components is disposed on the tailgate.

3. The refuse vehicle of claim 1, wherein the subsystem module is disposed on a roof of the body.

4. The refuse vehicle of claim 1, wherein the body further comprises a tailgate that is movably coupled to the refuse container, wherein the subsystem module is disposed on the tailgate.

5. The refuse vehicle of claim 4, wherein the housing is configured to contain both the fuel storage volume and the fuel cell.

6. The refuse vehicle of claim 5, wherein the subsystem module further comprises a fuel conduit and an electrical cable, and wherein the housing further comprises a partition separating at least a portion of the fuel conduit from the electrical cable.

7. The refuse vehicle of claim 1, wherein the body further comprises a tailgate that is movably coupled to the refuse container, wherein the fuel storage volume is disposed on the tailgate, and the subsystem module is supported by the refuse container.

8. The refuse vehicle of claim 1, wherein the fuel cell system further comprises an electric power take-off system including the motor and a hydraulic pump.

9. The refuse vehicle of claim 1, wherein the subsystem module is disposed on a forward end of the body.

10. A fuel cell system for a refuse vehicle, the fuel cell system comprising:
a plurality of primary components comprising a fuel storage volume, a fuel cell, an energy storage device, and a motor;
a subsystem module comprising a housing that is configured to be detachably coupled to the refuse vehicle, wherein at least two of the primary components are positioned within the housing, wherein at least one of the primary components is positioned external to the subsystem module and is coupled to the subsystem module.

11. The fuel cell system of claim 10, wherein the fuel cell and the energy storage device are positioned within the housing of the subsystem module.

12. The fuel cell system of claim 11, wherein the fuel storage vessel is positioned external to the subsystem module, the fuel storage vessel connected to the fuel cell of the subsystem module.

13. The fuel cell system of claim 10, wherein at least three of the primary components are positioned within the housing of the subsystem module.

14. The fuel cell system of claim 10 further comprising a second subsystem module comprising a housing, wherein at least two of the primary components are positioned within the housing of the second subsystem module, and wherein the second subsystem module is connected to the subsystem module.

15. The fuel cell system of claim 14, wherein the fuel storage vessel and the fuel cell are positioned within the housing of the subsystem module.

16. The fuel cell system of claim 15, wherein the energy storage device and the motor are positioned within the housing of the second subsystem module.

17. A refuse vehicle comprising:
a chassis;
a body coupled to the chassis and comprising a refuse container configured to receive and store refuse therein;
a fuel cell system coupled to at least one of the chassis or the body, the fuel cell system comprising:
a plurality of primary components comprising a fuel storage volume, a fuel cell, an energy storage device, and a motor;
a first subsystem module comprising a first housing coupled to a roof of the body of the refuse vehicle, wherein at least two of the primary components are positioned within the first housing; and
a second subsystem module comprising a second housing coupled to at least one of the chassis or the body of the refuse vehicle, the second subsystem module connected to the first subsystem module, wherein at least two of the primary components are positioned within the second housing.

18. The refuse vehicle of claim 17, wherein the fuel storage vessel and the fuel cell are positioned within the first housing.

19. The refuse vehicle of claim 18, wherein the energy storage device and the motor are positioned within the second housing.

20. The refuse vehicle of claim 17, wherein the body further includes a tailgate that is movably coupled to the refuse container, wherein the second subsystem module is disposed on the tailgate.
